(19) United States
(12) Patent Application Publication
(10) Pub. No.: US 2026/0339062 A1
(43) Pub. Date: Oct. 29, 2026

(54) OPTICAL FIBER COATING LAYER FORMING DEVICE AND OPTICAL FIBER COATING LAYER FORMING MOLD

(71) Applicant: Fujikura Ltd., Tokyo (JP)

(72) Inventors: Shuta Sagae, Sakura-shi (JP); Shigeru Saito, Sakura-shi (JP)

(73) Assignee: Fujikura Ltd., Tokyo (JP)

(21) Appl. No.: 19/118,459

(22) PCT Filed: Oct. 4, 2023
(86) PCT No.: PCT/JP2023/036236

§ 371 Date: Apr. 4, 2025

(30) Foreign Application Priority Data
Oct. 5, 2022 (JP) 2022-160995

(51) Int. Cl. G02B 6/44; B29C 35/08; B29C 39/10; B29D 11/00; B29L 11/00

(52) U.S. Cl. CPC G02B 6/4486; B29C 35/0805; B29C 35/0894; B29C 39/10; B29D 11/00875; B29C 2035/0827; B29L 2011/0075

(57) ABSTRACT

An optical fiber coating layer forming device that forms a coating layer on an outer peripheral surface of an optical fiber, includes: an optical fiber coating layer forming mold; a liquid resin dispenser that supplies a liquid resin to the optical fiber coating layer forming mold; and a light source that irradiates ultraviolet rays to the liquid resin supplied to the optical fiber coating layer forming mold. The optical fiber coating layer forming mold includes: an upper mold having a first facing surface; and a lower mold having a second facing surface that faces the first facing surface. The first facing surface has a first groove. The second facing surface has a second groove. The first groove and the second groove are connected with each other and constitute a main molding space in which the liquid resin is filled.

### TECHNICAL FIELD

The present invention relates to an optical fiber coating layer forming device and an optical fiber coating layer forming mold.

Priority is claimed on Japanese Patent Application No. 2022-160995, filed on Oct. 5, 2022, the content of which is incorporated herein by reference.

### BACKGROUND

In order to form a coating layer on an optical fiber, an optical fiber coating layer forming device having a pair of molds can be used. A mold groove is formed in each of the pair of molds. The two mold grooves are combined to form a mold space. A coating layer can be formed on an optical fiber by filling the mold space with a liquid resin and curing the liquid resin (for example, refer to Patent Document 1).

### PATENT LITERATURE

[PTL 1] Japanese Unexamined Patent Application, First Publication No. 2003-167150

In the above-described optical fiber coating layer forming device, air bubbles may remain in the liquid resin filling the mold space. When the air bubbles remain, recessed portions (bubble traces) are formed on the surface of the coating layer. Since the thickness of the coating layer is thin at the location where the recessed portion is formed, a protective function of the coating layer may be lowered.

### SUMMARY

One or more embodiments of the present invention provide an optical fiber coating layer forming device and an optical fiber coating layer forming mold capable of suppressing a deterioration of a protective function caused by formation of a recessed portion in an optical fiber coating layer.

According to an aspect of the present invention, there is provided an optical fiber coating layer forming device that forms a coating layer on an outer peripheral surface of an optical fiber, the optical fiber coating layer forming device including: an optical fiber coating layer forming mold; a liquid resin supply unit that supplies a liquid resin to the optical fiber coating layer forming mold; and a light source that irradiates ultraviolet rays to the liquid resin supplied to the optical fiber coating layer forming mold, in which the optical fiber coating layer forming mold includes an upper mold having a first facing surface and a lower mold having a second facing surface facing the first facing surface, a first groove is formed in the first facing surface, a second groove is formed in the second facing surface, the first groove and the second groove are connected with each other to constitute a main molding space where the liquid resin that is a material of the coating layer is filled, and when a direction orthogonal to a longitudinal direction of the main molding space and a facing direction of the first facing surface and the second facing surface is defined as a width direction, an expansion recessed portion constituting an expansion space expanding in the width direction from the main molding space is formed in at least one of the first facing surface and the second facing surface.

According to this configuration, air bubbles are less likely to remain in the liquid resin in the main molding space. Therefore, recessed portions (bubble traces) are less likely to be formed in the coating layer. Therefore, it is possible to form the coating layer having an excellent function of protecting the optical fiber.

One of the upper mold and the lower mold may be a mold having ultraviolet light transmittance, and a light blocking film that blocks the ultraviolet rays emitted from the light source may be formed on an upper surface or a lower surface of the expansion space constituted by the mold having ultraviolet light transmittance.

According to this configuration, since an irradiation amount of ultraviolet rays on the liquid resin in the expansion space can be suppressed, the liquid resin in the expansion space is less likely to be cured. Therefore, it is possible to form the coating layer without irregularly shaped portions such as burrs.

The upper mold and the lower mold may be molds having ultraviolet light transmittance, and a light blocking film that blocks the ultraviolet rays emitted from the light source may be formed on at least one of an upper surface and a lower surface of the expansion space.

According to this configuration, since an irradiation amount of ultraviolet rays on the liquid resin in the expansion space can be suppressed, the liquid resin in the expansion space is less likely to be cured. Therefore, it is possible to form the coating layer without irregularly shaped portions such as burrs.

In the optical fiber coating layer forming device, an introduction port for introducing the liquid resin to the main molding space may be formed in the upper mold or the lower mold, and a width of the expansion space may increase as a distance from the introduction port increases in the longitudinal direction.

According to this configuration, a flow resistance of the liquid resin in the expansion space can be reduced. Therefore, the supply pressure of the liquid resin can be reduced. Therefore, the coating layer can be easily formed. According to this configuration, since the width can be reduced while suppressing the flow resistance of the liquid resin in a range close to the introduction port, a volume of the expansion space can be reduced. Therefore, the amount of the liquid resin used can be suppressed.

A height of the expansion space may be 2 μm to 50 μm.

According to this configuration, by setting the height of the expansion space to 2 μm or more, it is possible to facilitate the flow of the liquid resin. By setting the height of the expansion space to 50 μm or less, it is possible to suppress the formation of burrs on the coating layer.

An aspect of the present invention, there is provided an optical fiber coating layer forming mold for forming a coating layer on an outer peripheral surface of an optical fiber, the optical fiber coating layer forming mold including: an upper mold having a first facing surface; a lower mold having a second facing surface facing the first facing surface, in which wherein a first groove is formed in the first facing surface, a second groove is formed in the second facing surface, the first groove and the second groove are connected with each other to constitute a main molding space where a liquid resin that is a material of the coating layer is filled, and when a direction orthogonal to a longitudinal direction of the main molding space and a facing direction of the first facing surface and the second facing surface is defined as a width direction, an expansion recessed portion constituting an expansion space extending in the width direction from the main molding space is formed in at least one of the first facing surface and the second facing surface.

According to this configuration, air bubbles are less likely to remain in the liquid resin in the main molding space. Therefore, recessed portions (bubble traces) are less likely to be formed in the coating layer. Therefore, it is possible to form the coating layer having an excellent function of protecting the optical fiber.

An aspect of the present invention provides an optical fiber coating layer forming device and an optical fiber coating layer forming mold capable of suppressing a deterioration of a protective function caused by formation of a recessed portion in an optical fiber coating layer.

### BRIEF DESCRIPTION OF THE DRAWINGS

FIG. 1 is an exploded perspective view of an optical fiber coating layer forming device of one or more embodiments.

FIG. 2 is a cross-sectional view of an optical fiber coating layer forming mold of one or more embodiments.

FIG. 3 is an exploded cross-sectional view of an optical fiber coating layer forming mold of one or more embodiments.

FIG. 4 is an enlarged cross-sectional view of an optical fiber coating layer forming mold of one or more embodiments.

FIG. 5 is a plan view of an optical fiber coating layer forming mold of one or more embodiments.

FIG. 6 is a cross-sectional view showing an example of a coating layer forming method for an optical fiber using the optical fiber coating layer forming device of one or more embodiments.

FIG. 7 is a cross-sectional view showing the coating layer forming method of an optical fiber following the previous view.

FIG. 8 is a cross-sectional view of an optical fiber coating layer forming mold of a comparative form.

FIG. 9 is a cross-sectional view showing another example of the coating layer forming method of an optical fiber using the optical fiber coating layer forming device of one or more embodiments.

FIG. 10 is a plan view of an optical fiber coating layer forming mold of a modification example.

### DETAILED DESCRIPTION

An optical fiber coating layer forming device and an optical fiber coating layer forming mold according to one or more embodiments will be described in detail with reference to the drawings.

### Optical Fiber Coating Layer Forming Device

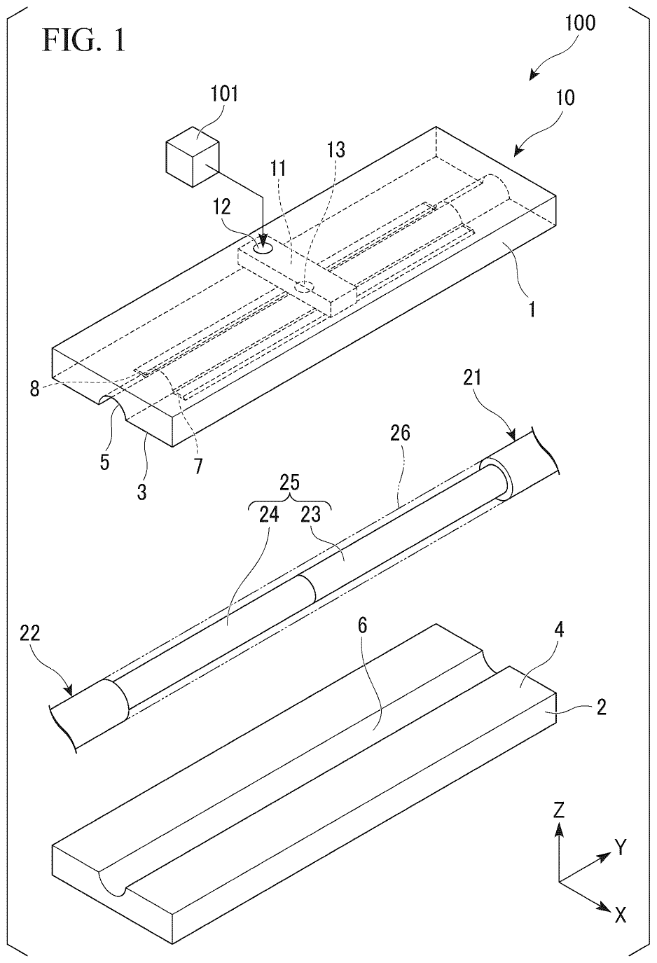

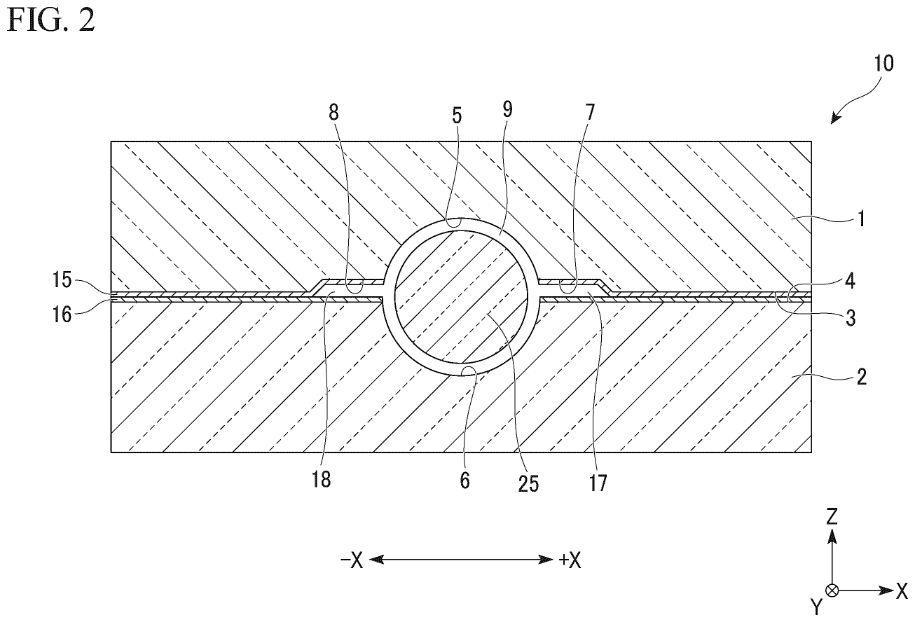

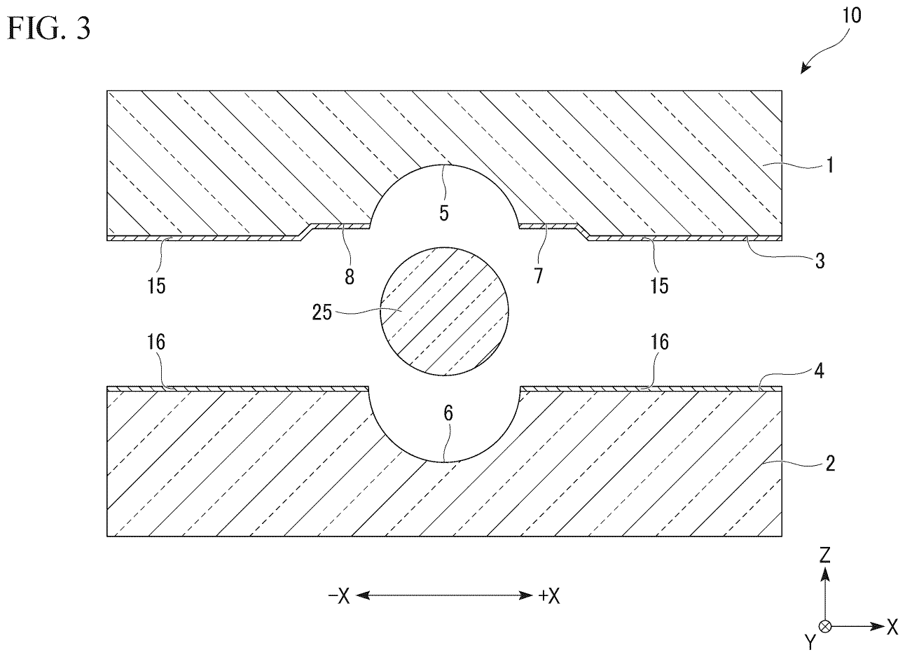

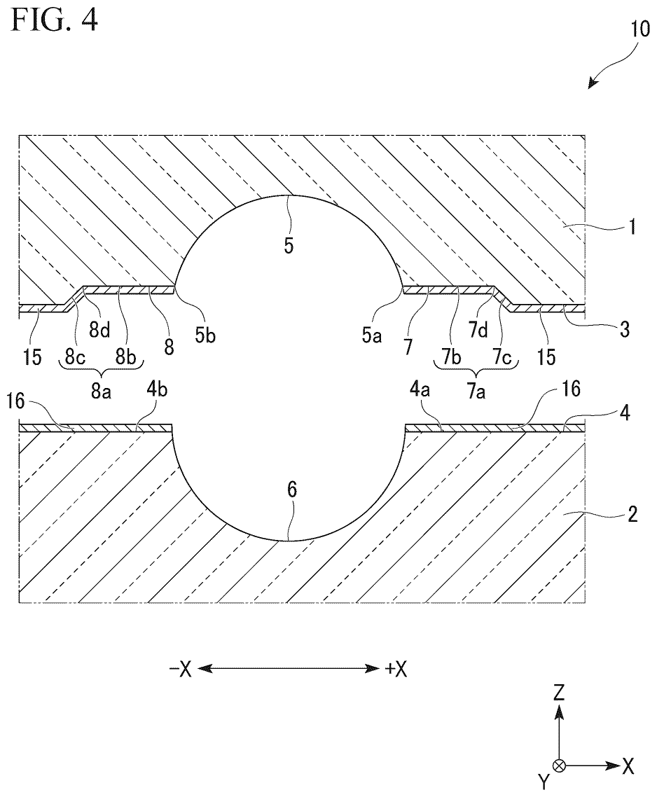

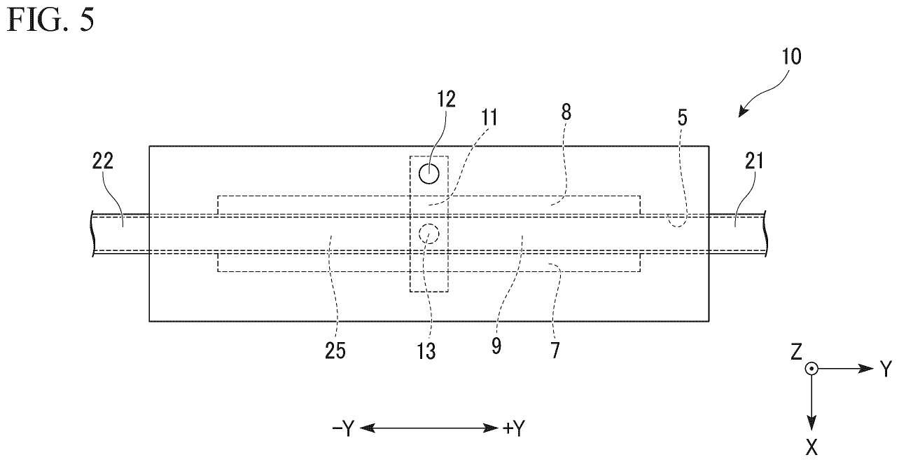

FIG. 1 is an exploded perspective view of an optical fiber coating layer forming device 100 according to one or more embodiments. The optical fiber coating layer forming device is also simply referred to as a “coating layer forming device”. FIG. 2 is a cross-sectional view of an optical fiber coating layer forming mold 10 according to one or more embodiments. The optical fiber coating layer forming mold is also simply referred to as a “coating layer forming mold”. FIG. 3 is an exploded cross-sectional view of the coating layer forming mold 10. FIG. 4 is an enlarged cross-sectional view of the coating layer forming mold 10. FIG. 5 is a plan view of the coating layer forming mold 10.

A positional relationship of each configuration of the coating layer forming device 100 by setting an XYZ orthogonal coordinate system will be described. A Y-axis direction is a direction along a longitudinal direction of a first groove 5. A Z-axis direction is a facing direction between a first facing surface 3 and a second facing surface 4. An X-axis direction is a direction orthogonal to both the Y-axis direction and the Z-axis direction. The Y-axis direction is a longitudinal direction Y. The Z-axis direction is a facing direction Z. The X-axis direction is a width direction X. One direction along the longitudinal direction Y is referred to as a “+Y direction”. A direction opposite to the +Y direction is referred to as a “−Y direction”. The facing direction Z is a height direction (up-down direction). One direction along the width direction X is referred to as a “+X direction”. A direction opposite to the +X direction is referred to as a “−X direction”. A plane along the width direction X and the longitudinal direction Y is referred to as an XY plane.

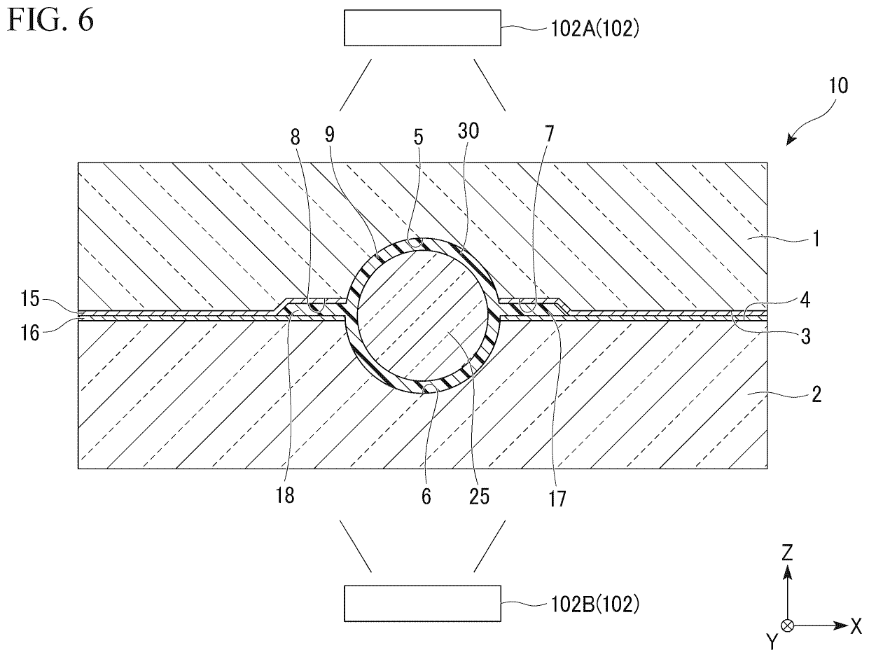

As shown in FIG. 1, the coating layer forming device 100 includes the coating layer forming mold 10, a liquid resin supply unit 101 (i.e., liquid resin dispenser), and a pair of light sources 102 (refer to FIG. 6). One or more embodiments form a coating layer (recoating layer) again on an optical fiber in which a coating layer has been removed. The recoating layer is an example of a coating layer.

The liquid resin supply unit 101 supplies an uncured liquid resin that is a material of a recoating layer 26 to the coating layer forming mold 10. The liquid resin is an ultraviolet curable liquid resin. For example, a urethane acrylate-based resin, an epoxy acrylate-based resin, a polybutazine acrylate-based resin, a silicone acrylate-based resin, and a polyester acrylate-based resin are exemplary examples of the ultraviolet curable liquid resin. When the coating layer (recoating layer) is formed again on the optical fiber, the liquid resin is also referred to as a recoat resin.

The light source 102 irradiates ultraviolet rays as curing light, to the liquid resin in the coating layer forming mold 10. One (first light source 102A) of the pair of light sources 102 is provided at a position away from a back surface (a surface opposite to the first facing surface 3) of an upper mold 1. The other (second light source 102B) of the pair of light sources 102 is provided at a position away from a back surface (a surface opposite to the second facing surface 4) of a lower mold 2 (refer to FIG. 6). The light emitted by the light source 102 is emitted from the back surface sides of the upper mold 1 and the lower mold 2 to cure the liquid resin in the coating layer forming mold 10.

### Optical Fiber Coating Layer Forming Mold

As shown in FIGS. 1 to 3, the coating layer forming mold 10 includes the upper mold 1 (first mold) and the lower mold 2 (second mold). At least one of the upper mold 1 and the lower mold 2 is movable up and down. The upper mold 1 and the lower mold 2 can be switched between a state in which the first facing surface 3 and the second facing surface 4 are overlapped (closed state) (refer to FIG. 2), and the first facing surface 3 and the second facing surface 4 are separated from each other (open state) (refer to FIG. 3). The coating layer forming mold is also referred to as a recoating layer forming mold or a recoating mold.

The upper mold 1 and the lower mold 2 are formed of a material which is capable of transmitting ultraviolet rays which cures the liquid resin in a main molding space 9. For example, silica glass or the like is exemplary examples of the material of the upper mold 1 and the lower mold 2. The upper mold 1 and the lower mold 2 have, for example, an ultraviolet transmissivity of 50% or more. The upper mold 1 and the lower mold 2 are molds having ultraviolet light transmittance. The mold having ultraviolet light transmittance is formed of a material through which ultraviolet rays emitted from the light source 102 are transmitted.

As shown in FIG. 4, the upper mold 1 has the first facing surface 3 along the XY plane. The first facing surface 3 is formed with a first groove 5, a first expansion recessed portion 7, and a second expansion recessed portion 8. The first groove 5 has a shape corresponding to the recoating layer 26 (refer to FIG. 1). The cross-sectional shape (the shape of the cross section orthogonal to the longitudinal direction Y) of the first groove 5 is a semicircular shape. A side edge of the first groove 5 in the +X direction is referred to as a first side edge 5a. The side edge of the first groove 5 in the −X direction is referred to as a second side edge 5b.

The lower mold 2 has the second facing surface 4 along the XY plane. The lower mold 2 is disposed so that the second facing surface 4 faces the first facing surface 3. A second groove 6 along the longitudinal direction Y is formed in the second facing surface 4. The second groove 6 is formed at a position facing the first groove 5. The second groove 6 has a shape corresponding to the recoating layer 26 (refer to FIG. 1). The cross-sectional shape (the shape of the cross section orthogonal to the longitudinal direction Y) of the second groove 6 is a semicircular shape. An inner diameter of the second groove 6 is the same as an inner diameter of the first groove 5.

As shown in FIG. 2, when the upper mold 1 and the lower mold 2 are closed, the first groove 5 and the second groove 6 are connected to form the main molding space 9. The main molding space 9 has a shape corresponding to the recoating layer 26 (refer to FIG. 1). The main molding space 9 is a columnar space having a central axis along the longitudinal direction Y. The main molding space 9 is a space which is filled with the liquid resin and where the recoating layer 26 is formed to cure the liquid resin. The main molding space 9 is capable of accommodating the optical fiber 25 for which a coating layer is to be formed. An inner diameter of the main molding space 9 is larger than an outer diameter of the optical fiber 25.

As shown in FIG. 3, the first expansion recessed portion 7 is formed to be connected to the first groove 5 in the +X direction with respect to the first groove 5. The first expansion recessed portion 7 is a strip-shaped groove along the longitudinal direction Y (refer to FIG. 1).

As shown in FIG. 4, an inner surface 7a (first inner surface) of the first expansion recessed portion 7 has a main surface 7b and an end surface 7c. The main surface 7b extends in the +X direction along the XY plane from the first side edge 5a of the first groove 5. The end surface 7c is formed on an outer edge 7d of the main surface 7b in the +X direction. The end surface 7c is, for example, an inclined surface that gradually descends from the outer edge 7d along a widening direction (+X direction). A depth (height difference between the first facing surface 3 and the main surface 7b) of the first expansion recessed portion 7 with respect to the first facing surface 3 is smaller than the depth of the first groove 5.

The inner surface 7a of the first expansion recessed portion 7 is an example of an upper surface of a first expansion space 17. A region of the second facing surface 4 facing the inner surface 7a of the first expansion recessed portion 7 is an inner surface 4a (first facing inner surface). The inner surface 4a is an example of a lower surface of the first expansion space 17.

As shown in FIG. 2, the first expansion recessed portion 7 forms the first expansion space 17 between the first expansion recessed portion 7 and the second facing surface 4 when the upper mold 1 and the lower mold 2 are closed. The first expansion space 17 is a space extended in the width direction (+X direction) from the main molding space 9. The first expansion space 17 communicates with the main molding space 9. The first expansion space 17 is a space formed by the inner surface 7a of the first expansion recessed portion 7 and the inner surface 4a of the lower mold 2 (refer to FIG. 4). The inner surface 7a of the first expansion recessed portion 7 is a region of the upper mold 1 facing the first expansion space 17. The inner surface 4a of the lower mold 2 is a region of the lower mold 2 facing the first expansion space 17.

As shown in FIG. 3, the second expansion recessed portion 8 is formed to be connected to the first groove 5 in the −X direction with respect to the first groove 5. The second expansion recessed portion 8 is a strip-shaped groove along the longitudinal direction Y (refer to FIG. 1).

As shown in FIG. 4, an inner surface 8a (second inner surface) of the second expansion recessed portion 8 has a main surface 8b and an end surface 8c. The main surface 8b extends in the −X direction along the XY plane from the second side edge 5b of the first groove 5. The end surface 8c is formed on an outer edge 8d of the main surface 8b in the −X direction. The end surface 8c is, for example, an inclined surface that gradually descends from the outer edge 8d along a widening direction (−X direction). A depth (height difference between the first facing surface 3 and the main surface 8b) of the second expansion recessed portion 8 with respect to the first facing surface 3 is smaller than the depth of the first groove 5.

The inner surface 8a of the second expansion recessed portion 8 is an example of an upper surface of the second expansion space 18. A region of the second facing surface 4 facing the inner surface 8a of the second expansion recessed portion 8 is an inner surface 4b (second facing inner surface). The inner surface 4b is an example of a lower surface of the second expansion space 18.

A width of the second expansion recessed portion 8 may be the same as a width of the first expansion recessed portion 7. The depth of the second expansion recessed portion 8 may be the same as the depth of the first expansion recessed portion 7.

As shown in FIG. 2, the second expansion recessed portion 8 forms the second expansion space 18 between the second expansion recessed portion 8 and the second facing surface 4 when the upper mold 1 and the lower mold 2 are closed. The second expansion space 18 is a space extended in the width direction (−X direction) from the main molding space 9. The second expansion space 18 communicates with the main molding space 9. The second expansion space 18 is a space formed by the inner surface 8a of the second expansion recessed portion 8 and the inner surface 4b of the lower mold 2 (refer to FIG. 4). The inner surface 8a of the second expansion recessed portion 8 is a region of the upper mold 1 facing the second expansion space 18. The inner surface 4b of the lower mold 2 is a region of the lower mold 2 facing the second expansion space 18.

The first expansion recessed portion 7 and the second expansion recessed portion 8 constitute the first expansion space 17 and the second expansion space 18 that are expanded in the width direction X (+X direction and −X direction) from the main molding space 9.

The coating layer forming mold 10 of one or more embodiments has the expansion spaces 17 and 18 extended from the main molding space 9 to both sides in the width direction X, but the expansion direction of the expansion space is not limited to both sides in the width direction X and may be on one side. That is, the coating layer forming mold may have the expansion space expanded to at least one side in the width direction X. “One side in the width direction X” is any one of the +X direction and the −X direction. The coating layer forming mold may adopt, for example, a configuration in which only one of the first expansion recessed portion 7 and the second expansion recessed portion 8 is formed in the first facing surface 3. In the coating layer forming mold, it suffices when the expansion recessed portion constituting the expansion space expanded in the width direction X (one side or both sides in the width direction X) is formed in at least one of the first facing surface and the second facing surface.

The height (height difference between the main surface 7b and the second facing surface 4) of the first expansion space 17 and the height (height difference between the main surface 8b and the second facing surface 4) of the second expansion space 18 may be in a range of 2 μm to 50 μm, and may be in a range of 20 μm to 40 μm. By setting the heights of the expansion spaces 17 and 18 to 2 μm or more, it is possible to facilitate the flow of the liquid resin. By setting the heights of the expansion spaces 17 and 18 to 20 μm or more, it is possible to further facilitate the flow of the liquid resin. By setting the heights of the expansion spaces 17 and 18 to 50 μm or less, the liquid resins in the expansion spaces 17 and 18 are less likely to be irradiated with the ultraviolet rays from the light source 102 (refer to FIG. 6). Therefore, it is possible to prevent burrs from being formed in the recoating layer 26 caused by the curing of the liquid resins in the expansion spaces 17 and 18. When the heights of the expansion spaces 17 and 18 are set to 40 μm or less, it is possible to further suppress the formation of burrs.

As shown in FIG. 5, the first expansion recessed portion 7 and the second expansion recessed portion 8 have a constant width (uniform width) in the longitudinal direction Y. According to this configuration, the maximum widths of the expansion spaces 17 and 18 can be reduced, which is advantageous in reducing the size of the coating layer forming mold 10.

The first expansion recessed portion 7 and the second expansion recessed portion 8 can be formed on the first facing surface 3 and the second facing surface 4 by etching or the like, for example.

As shown in FIG. 3, a first light blocking film 15 is formed on the inner surface 7a of the first expansion recessed portion 7, the inner surface 8a of the second expansion recessed portion 8, and the first facing surface 3. The first light blocking film 15 can block the ultraviolet rays emitted from the first light source 102A (refer to FIG. 6) to the expansion spaces 17 and 18. The first light blocking film 15 is not formed on the inner surface of the first groove 5.

A second light blocking film 16 is formed on the second facing surface 4. The second light blocking film 16 can block the ultraviolet rays emitted from the second light source 102B (refer to FIG. 6) to the expansion spaces 17 and 18. The second light blocking film 16 is not formed on the inner surface of the second groove 6.

Since the light blocking film is formed on the inner surface 7a (refer to FIG. 4) of the first expansion recessed portion 7, the inner surface 8a (refer to FIG. 4) of the second expansion recessed portion 8, and the second facing surface 4, the light blocking films sandwich the expansion spaces 17 and 18. Furthermore, the light blocking film may cover the entire region of the inner surface of the expansion spaces 17 and 18.

For example, the first light blocking film 15 and the second light blocking film 16 are formed of a metal such as chromium (Cr). The first light blocking film 15 and the second light blocking film 16 are formed by ion plating or the like.

As shown in FIG. 1, an introduction portion 11 is formed in the upper mold 1. The introduction portion 11 is a flow path for introducing the uncured liquid resin into the main molding space 9. The introduction portion 11 has an inflow port 12 and an introduction port 13. The inflow port 12 receives the liquid resin from the liquid resin supply unit 101 into the introduction portion 11. The introduction port 13 introduces the liquid resin in the introduction portion 11 to the main molding space 9. The introduction port 13 is formed at an intermediate position of the main molding space 9 in the longitudinal direction Y. The introduction port 13 is formed in a center of the main molding space 9 in the longitudinal direction Y, for example. The introduction port 13 is not limited to the center of the main molding space 9 in the longitudinal direction Y as shown in FIG. 1, and may be formed at any position in the main molding space 9 in the longitudinal direction Y. For example, the introduction port 13 may be formed at a position closer to the end of the main molding space 9 than the center in the longitudinal direction Y.

### Coating Layer Forming Method of Optical Fiber

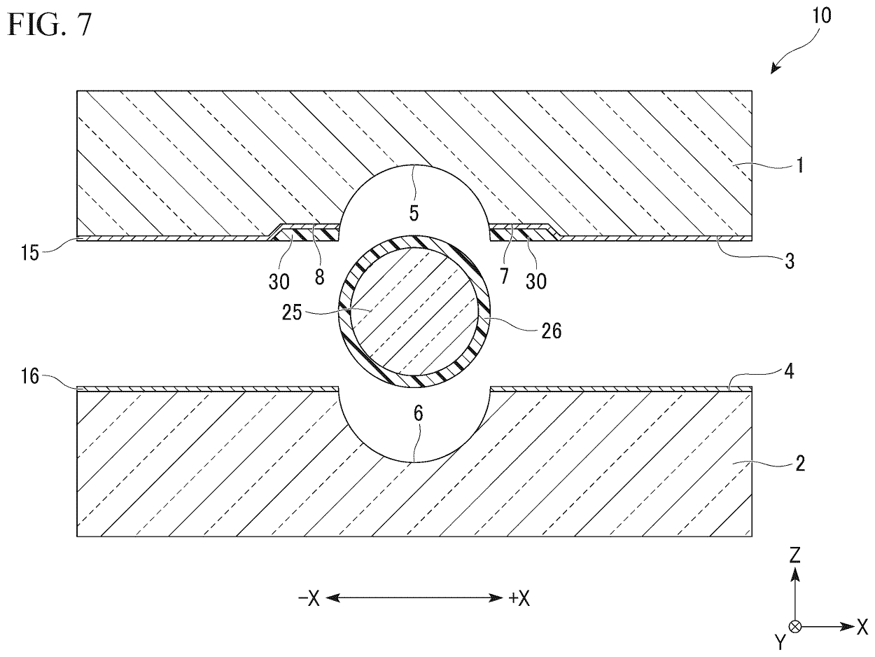

Next, an example of a coating layer forming method for an optical fiber using the coating layer forming device 100 will be described. FIG. 6 is a cross-sectional view showing an example of the coating layer forming method of an optical fiber using the coating layer forming device 100. FIG. 7 is a cross-sectional view showing the coating layer forming method of an optical fiber following the previous view.

The optical fiber 25 shown in FIG. 1 is a bare fiber for which the coating layer is to be formed. The optical fiber 25 includes a first bare fiber 23 protruding from a first optical fiber 21 and a second bare fiber 24 protruding from a second optical fiber 22. The first bare fiber 23 and the second bare fiber 24 are butt-connected by fusion splicing. One or more embodiments form the recoating layer on the optical fiber 25 which is a bare fiber from which the coating layer has been removed.

An optical fiber for which the coating layer is to be formed is not limited to a bare fiber that is butt-connected. For example, an optical fiber having a Fiber Bragg Grating (FBG) can be an exemplary example of the optical fiber for which a coating layer is to be formed. The optical fiber for which the coating layer is to be formed may be an optical fiber from which the coating layer has been removed for repair or the like. The optical fiber for which the coating layer is to be formed is not limited to the bare fiber, and may be an optical fiber having a coating layer.

As shown in FIG. 2, the upper mold 1 and the lower mold 2 are closed. The main molding space 9 is formed by the first groove 5 and the second groove 6. The optical fiber 25 is to be inserted through the main molding space 9. The first expansion space 17 is formed between the first expansion recessed portion 7 and the second facing surface 4. The second expansion space 18 is formed between the second expansion recessed portion 8 and the second facing surface 4.

As shown in FIG. 1, an uncured liquid resin (ultraviolet curable resin) is supplied from the liquid resin supply unit 101 to the introduction portion 11 through the inflow port 12. The liquid resin is supplied to the main molding space 9 (refer to FIG. 2) through the introduction port 13.

As shown in FIG. 6, the liquid resin 30 supplied to the main molding space 9 spreads over the main molding space 9. The liquid resin 30 fills gaps between the inner peripheral surfaces of the grooves 5 and 6 and the outer peripheral surface of the optical fiber 25. The liquid resin 30 covers the outer peripheral surface of the optical fiber 25 over the entire circumference. A portion of the liquid resin 30 flows from the main molding space 9 into the first expansion space 17 and the second expansion space 18. The liquid resin 30 flows from the introduction port 13 to both sides (+Y direction and −Y direction: left-right direction in FIG. 5) of the main molding spaces 9 and the expansion spaces 17 and 18 in the longitudinal directions Y.

The coating layer forming mold 10 is irradiated with the ultraviolet rays by the first light source 102A and the second light source 102B. The ultraviolet rays from the first light source 102A are transmitted through the upper mold 1 and the liquid resin 30 in the main molding space 9 is irradiated with the ultraviolet rays. The liquid resin 30 in the first groove 5 is mainly irradiated with the ultraviolet rays from the first light source 102A. The ultraviolet rays from the second light source 102B are transmitted through the lower mold 2 and the liquid resin 30 in the main molding space 9 is irradiated with the ultraviolet rays. The liquid resin 30 in the second groove 6 is mainly irradiated with the ultraviolet rays from the second light source 102B.

A part of the ultraviolet rays from the first light source 102A may be transmitted through the optical fiber 25 and the liquid resin 30 in the second groove 6 is irradiated with the ultraviolet rays. A part of the ultraviolet rays from the second light source 102B may be transmitted through the optical fiber 25 and the liquid resin 30 in the first groove 5 is irradiated with the ultraviolet rays.

The liquid resin 30 in the main molding space 9 is cured by irradiation with ultraviolet rays and becomes the recoating layer 26 (refer to FIG. 7). The recoating layer 26 covers the outer peripheral surface of the optical fiber 25 over the entire circumference.

Since the light blocking films 15 and 16 are formed on the inner surfaces of the first expansion space 17 and the second expansion space 18, the ultraviolet rays which are emitted to the expansion spaces 17 and 18 from the first light source 102A are blocked by the first light blocking film 15. The ultraviolet rays emitted from the second light source 102B to the expansion spaces 17 and 18 are blocked by the second light blocking film 16. Therefore, ultraviolet ray is hardly irradiated to the liquid resin 30 in the expansion spaces 17 and 18. Therefore, curing of the liquid resin 30 is less likely to proceed in the expansion spaces 17 and 18.

As shown in FIG. 7, when the upper mold 1 and the lower mold 2 are separated from each other, the optical fiber 25 in which the recoating layer 26 is formed can be taken out. Since the liquid resin 30 in the expansion spaces 17 and 18 is uncured, the recoating layer 26 is separated from the liquid resin 30 in the expansion spaces 17 and 18.

### Effects of Coating Layer Forming Device and Coating Layer Forming Mold of Embodiments

In the coating layer forming device 100 of one or more embodiments, the expansion recessed portions 7 and 8 are formed in the first facing surface 3 of the coating layer forming mold 10. The expansion recessed portions 7 and 8 constitute the expansion spaces 17 and 18 that are extended in the width direction X from the main molding space 9. Therefore, air bubbles are less likely to remain in the liquid resin 30 in the main molding space 9. Therefore, it is possible that the recessed portion (bubble trace) is less likely to be formed in the recoating layer 26. Therefore, the recoating layer 26 having an excellent function of protecting the optical fiber 25 can be formed. Since the recoating layer 26 has no recessed portion, the recoating layer 26 may also be used from the viewpoint of appearance.

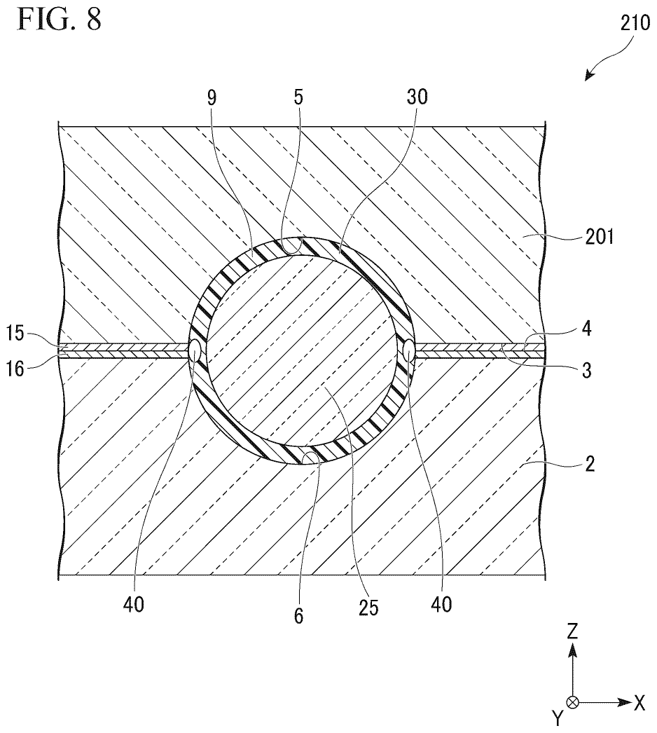

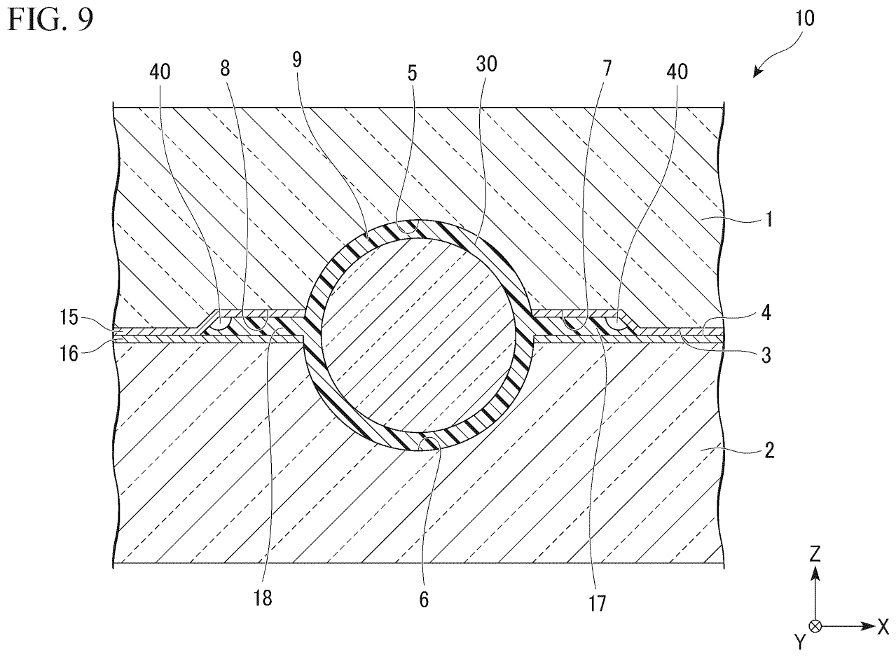

It will be described that air bubbles are less likely to remain in the main molding space 9 with reference to FIGS. 8 and 9. FIG. 8 is a cross-sectional view of a coating layer forming mold 210 of a comparative form. As shown in FIG. 8, the coating layer forming mold 210 includes an upper mold 201 and a lower mold 2. An expansion recessed portion is not formed in the upper mold 201 and the lower mold 2. Therefore, the coating layer forming mold 210 does not have an expansion space. In a case where air bubbles 40 are generated in the liquid resin 30, the air bubbles 40 are likely to remain in the vicinity of the joint between the two molds 201 and 2.

FIG. 9 is a cross-sectional view showing another example of the coating layer forming method of an optical fiber using the coating layer forming device 100 of one or more embodiments. Since the coating layer forming mold 10 has the expansion spaces 17 and 18, the air bubbles 40 are formed in the expansion spaces 17 and 18 even if the air bubbles 40 are generated. Therefore, the air bubbles 40 are unlikely to remain in the main molding space 9.

Since the coating layer forming device 100 of one or more embodiments includes the expansion spaces 17 and 18 so that a cross sectional area (area of a cross section orthogonal to the longitudinal direction Y) of the internal space of the coating layer forming mold 10 can increase. Therefore, the flow resistance of the liquid resin 30 can be reduced. Therefore, the supply pressure of the liquid resin 30 can be lowered. Therefore, the recoating layer 26 can be easily formed.

Since the coating layer forming device 100 can reduce the supply pressure of the liquid resin 30, it is possible to prevent the liquid resin 30 from leaking out of the main molding space 9 and the expansion spaces 17 and 18. Therefore, when cleaning the coating layer forming mold 10 after use, it is possible to reduce the time and effort required to remove the leaked liquid resin. Therefore, the cleaning work becomes easy.

In the coating layer forming device 100, the first light blocking film 15 is formed on the upper surfaces (inner surfaces 7a and 8a) of the expansion spaces 17 and 18 in the upper mold 1 through which the ultraviolet rays from the first light source 102A are transmitted (refer to FIG. 4). The second light blocking film 16 is formed on the lower surfaces (inner surfaces 4a and 4b) of the expansion spaces 17 and 18 in the lower mold 2 through which the ultraviolet rays from the second light source 102B are transmitted (refer to FIG. 4). Therefore, an irradiation amount of the ultraviolet rays to the liquid resin 30 in the expansion spaces 17 and 18 can be suppressed. Therefore, the liquid resin 30 in the expansion spaces 17 and 18 is hardly cured. Therefore, the recoating layer 26 can be formed without irregularly shaped portions such as burrs.

In the coating layer forming device 100, since the light blocking films 15 and 16 are formed on the upper surfaces (inner surfaces 7a and 8a) and the lower surfaces (inner surfaces 4a and 4b) of the expansion spaces 17 and 18 (refer to FIG. 4), the irradiation amount of ultraviolet rays on the liquid resin 30 in the expansion spaces 17 and 18 can be suppressed. Therefore, the recoating layer 26 can be formed without irregularly shaped portions such as burrs.

In the coating layer forming mold 10 of one or more embodiments, the expansion recessed portions 7 and 8 are formed in the first facing surface 3. The expansion recessed portions 7 and 8 constitute the expansion spaces 17 and 18 that are extended in the width direction X from the main molding space 9. Therefore, air bubbles are less likely to remain in the liquid resin 30 in the main molding space 9. Therefore, it is possible that the recessed portion (bubble trace) is less likely to be formed in the recoating layer 26. Therefore, the recoating layer 26 having an excellent function of protecting the optical fiber 25 can be formed. Since the recoating layer 26 has no recessed portion, the recoating layer 26 may also be used from the viewpoint of appearance.

### [Coating Layer Forming Mold] (Modification Example)

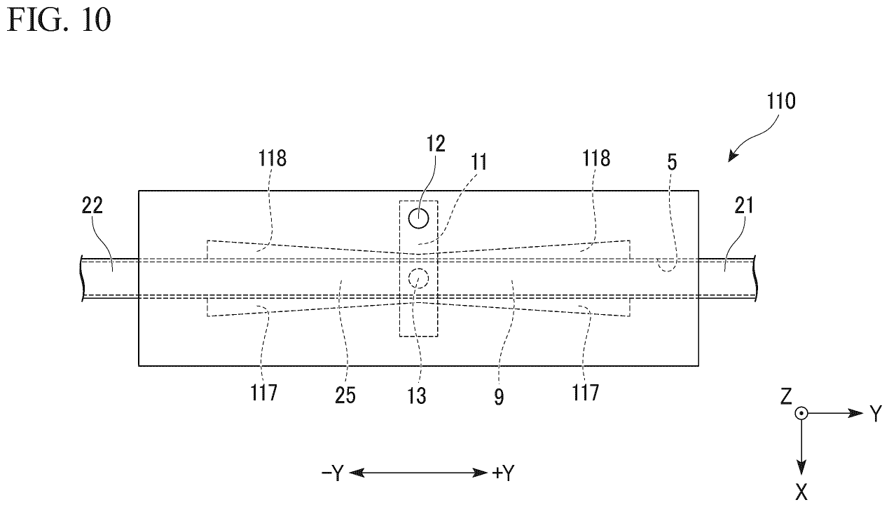

FIG. 10 is a plan view of a coating layer forming mold 110 of the modification example.

As shown in FIG. 10, widths of the first expansion space 117 and the second expansion space 118 increase as they are farther from the introduction port 13 in the longitudinal direction Y. Specifically, the widths of the expansion spaces 117 and 118 gradually increase from the introduction port 13 towards the +Y direction. The widths of the expansion spaces 117 and 118 gradually increase from the introduction port 13 towards the −Y direction. The coating layer forming mold 110 is the same as the coating layer forming mold 10 shown in FIG. 5 and the like except for the configurations other than the expansion spaces 117 and 118.

In general, a liquid resin flowing through an internal space of a mold has a low flow resistance in a range close to an introduction port and tends to have a high flow resistance in a range far from an introduction port. Meanwhile, the coating layer forming mold 110 has the expansion spaces 117 and 118 having a larger width as the distance from the introduction port 13 increases. Therefore, it is possible to increase the cross sectional areas of the expansion spaces 117 and 118 in a range far from the introduction port 13 and reduce the flow resistance of the liquid resin. Therefore, the supply pressure of the liquid resin can be reduced. Therefore, the recoating layer 26 can be easily formed. Since the widths of the expansion spaces 117 and 118 can be reduced while suppressing the flow resistance of the liquid resin in a range close to the introduction port 13, the volumes of the expansion spaces 117 and 118 can be reduced. Therefore, the amount of the liquid resin used can be suppressed.

The present invention is not limited to the above examples, and can be appropriately modified without departing from the spirit of the invention.

In the above-described embodiments, it is assumed that the coating layer (recoating layer 26) is formed again on the optical fiber 25 in which the coating layer has been removed. However, the coating layer forming device of the embodiments can be used to form a coating layer (coating layer to be formed for the first time) that is not a recoating layer.

In the coating layer forming mold 10 shown in FIG. 2 or the like, the expansion recessed portions 7 and 8 are formed on the first facing surface 3 of the upper mold 1, but the configuration of the coating layer forming mold is not limited thereto. The expansion recessed portion may be formed in at least one of the first facing surface and the second facing surface. That is, the first expansion recessed portion and the second expansion recessed portion may be formed only on the second facing surface among the first facing surface and the second facing surface. The first expansion recessed portion and the second expansion recessed portion may be formed in both the first facing surface and the second facing surface.

In the coating layer forming mold 10, both the upper mold 1 and the lower mold 2 may be the molds having ultraviolet light transmittance formed of a material through which ultraviolet rays are transmitted, or only one thereof may be the mold having ultraviolet light transmittance. The light blocking film is formed in a region facing the expansion space of the mold having ultraviolet light transmittance. For example, in a case where the upper mold is a mold having ultraviolet light transmittance and the lower mold is a mold that does not have ultraviolet light transmittance, the light blocking film is formed at least in a region of the upper mold facing the expansion space. In a case where the lower mold is a mold having ultraviolet light transmittance and the upper mold is a mold that does not have ultraviolet light transmittance, the light blocking film is formed at least in a region of the lower mold which faces the expansion space.

The light blocking films 15 and 16 are formed on both the upper surfaces (inner surfaces 7a and 8a) and the lower surfaces (inner surfaces 4a and 4b) of the expansion spaces 17 and 18, but the light blocking film may be formed on at least one of the upper surface and lower surface of the expansion space. For example, the upper mold 1 and the lower mold 2 are molds having ultraviolet light transmittance, and a light blocking film 15 that blocks the ultraviolet rays emitted from the light source 102 is formed on at least one of an upper surface and a lower surface of the expansion space. In a case where the light blocking film is formed only on the upper surface of the expansion space, only the first light source 102A of the two light sources 102 in FIG. 6 may be used. Only the second light source 102B of the two light sources 102 in FIG. 6 may be used in a case where the light blocking film is formed only on the lower surface of the expansion space.

In the above-described example, both of the two light sources 102 in FIG. 6 are used, but only one of the two light sources 102 may be used for the irradiation of the ultraviolet rays.

The coating layer forming mold of the embodiments also includes a configuration without the light blocking film. In the absence of the light blocking film, the liquid resin in the expansion space may also be cured, but the liquid resin cured in the expansion space can be cut off from the coating layer after molding.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1: upper mold
2: lower mold
3: first facing surface
4: second facing surface
4a, 4b: inner surface (lower surface)
5: first groove
6: second groove
7: first expansion recessed portion
7a: inner surface (upper surface)
8: second expansion recessed portion
8a: inner surface (upper surface)
9: main molding space
10, 110: optical fiber coating layer forming mold
13: introduction port
15: first light blocking film
16: second light blocking film
17,117: first expansion space
18, 118: second expansion space
25: optical fiber
26: recoating layer (coating layer)
30: liquid resin
100: optical fiber coating layer forming device
101: liquid resin supply unit
102: light source
X: width direction
Y: longitudinal direction
Z: facing direction

1. An optical fiber coating layer forming device that forms a coating layer on an outer peripheral surface of an optical fiber, the optical fiber coating layer forming device comprising:
an optical fiber coating layer forming mold;
a liquid resin dispenser that supplies a liquid resin to the optical fiber coating layer forming mold; and
a light source that irradiates ultraviolet rays to the liquid resin supplied to the optical fiber coating layer forming mold, wherein
the optical fiber coating layer forming mold comprises:
an upper mold having a first facing surface; and
a lower mold having a second facing surface that faces the first facing surface,
the first facing surface has a first groove,
the second facing surface has a second groove,
the first groove and the second groove are connected with each other and constitute a main molding space in which the liquid resin is filled, and
at least one of the first facing surface and the second facing surface has an expansion recessed portion that constitutes an expansion space expanding from the main molding space in a width direction of the main molding space, the width direction being orthogonal to a longitudinal direction of the main molding space and a facing direction in which the first facing surface and the second facing surface face each other.

2. The optical fiber coating layer forming device according to claim 1, wherein
the upper mold transmits ultraviolet light, and
an upper surface of the expansion space that constitutes the upper mold comprises a light blocking film that blocks the ultraviolet rays.

3. The optical fiber coating layer forming device according to claim 1, wherein
both of the upper mold and the lower mold transmit ultraviolet light, and
at least one of an upper surface and a lower surface of the expansion space comprises a light blocking film that blocks the ultraviolet rays.

4. The optical fiber coating layer forming device according to claim 1, wherein
either the upper mold or the lower mold has an introduction port through which the liquid resin is introduced to the main molding space, and
a width of the expansion space increases as a distance from the introduction port increases in the longitudinal direction.

5. The optical fiber coating layer forming device according to claim 1, wherein a height of the expansion space is 2 μm to 50 μm.

6. An optical fiber coating layer forming mold for forming a coating layer on an outer peripheral surface of an optical fiber, the optical fiber coating layer forming mold comprising:
an upper mold having a first facing surface; and
a lower mold having a second facing surface that faces the first facing surface, wherein
the first facing surface has a first groove,
the second facing surface has a second groove,
the first groove and the second groove are connected with each other and constitute a main molding space in which a liquid resin is filled, and
at least one of the first facing surface and the second facing surface has an expansion recessed portion that constitutes an expansion space expanding from the main molding space in a width direction of the main molding space, the width direction being orthogonal to a longitudinal direction of the main molding space and a facing direction in which the first facing surface and the second facing surface face each other.

7. The optical fiber coating layer forming device according to claim 1, wherein
the lower mold transmits ultraviolet light, and
a lower surface of the expansion space that constitutes the lower mold comprises a light blocking film that blocks the ultraviolet rays
